(19) United States
(12) Patent Application Publication
(10) Pub. No.: US 2006/0221382 A1
(43) Pub. Date: Oct. 5, 2006

(54) Supporting a filter pipeline for a spooling module

(75) Inventors: Khaled S. Sedky, Sammamish, WA (US); Oliver H. Foehr, Mercer Island, WA (US); Adrian F. Maxa, Kirkland, WA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/098,993

(22) Filed: Apr. 5, 2005

(51) Int. Cl. G06F 3/12

(52) U.S. Cl. 358/1.15; 358/1.5

(57) ABSTRACT

Supporting a filter pipeline for a spooling module includes a spooling module loading a print processor, and the print processor loading a filter pipeline having a plurality of filters. Each of the plurality of filters performs one or more processing functions on the print job prior to the print job being forwarded to a target entity.

### TECHNICAL FIELD

This invention relates to printing and spooling techniques, and particularly to supporting a filter pipeline for a spooling module.

### BACKGROUND

Computing devices commonly render documents using spooling techniques (where “spool” is an acronym for Simultaneous Peripheral Operations On-Line). In a typical spooling technique, an application on the computing device generates a document and a spooler on the computing device stores it in a spool storage. The spool storage can be implemented using memory (such as RAM memory), or, more commonly, using disk storage. When the computing device is ready to process the document, the computing device can then access the document from the spool storage and convert it to a format that is compatible with the format expectations of an output device (such as a format defined by the Page Description Language). Various processing functions can also be performed on the document, such as changing the order in which the pages are printed, adding a watermark to the pages, having the document be printed double-sided, having the document printed half-size (so that two pages of the document are printed on a single physical sheet of paper), and so on. The computing device can then forward the converted document to the output device, such as a printer, whereupon the output device prints the document or performs some other processing with respect to the document.

New techniques are being developed to perform these processing functions, allowing new processing functions to be more easily added by various manufacturers and developers. Although such new techniques can have numerous advantages, they also sometimes are problematic in that they do not work well with previously existing systems (sometimes referred to as legacy systems). There is accordingly a need for better ways in which such new techniques can be used with previously existing systems.

### SUMMARY

Supporting a filter pipeline for a spooling module is described herein.

In accordance with certain aspects, a print queue of a spooling module receives a print job from an application module. The spooling module loads a print processor, which in turn loads a filter pipeline having a plurality of filters. Each of the plurality of filters performs one or more processing functions on the print job prior to the print job being forwarded to a target entity.

### BRIEF DESCRIPTION OF THE DRAWINGS

The same numbers are used throughout the document to reference like components and/or features.

FIG. 1 shows an example system for spooling print jobs.

FIG. 2 illustrates another example system for spooling print jobs.

FIG. 3 is a flowchart illustrating an example process for supporting a filter pipeline.

FIG. 4 illustrates an example computer environment that can be used to implement the functionality described herein.

### DETAILED DESCRIPTION

Supporting a filter pipeline for a spooling module is discussed herein. When carrying out a print job, a spooling module loads a print processor which in turn loads a filter pipeline having one or more filters to process the print job information. The print processor and filter pipeline are separate from the spooling module, allowing a previously existing spooling module to take advantage of the benefits of the filter pipeline without requiring a new spooling module.

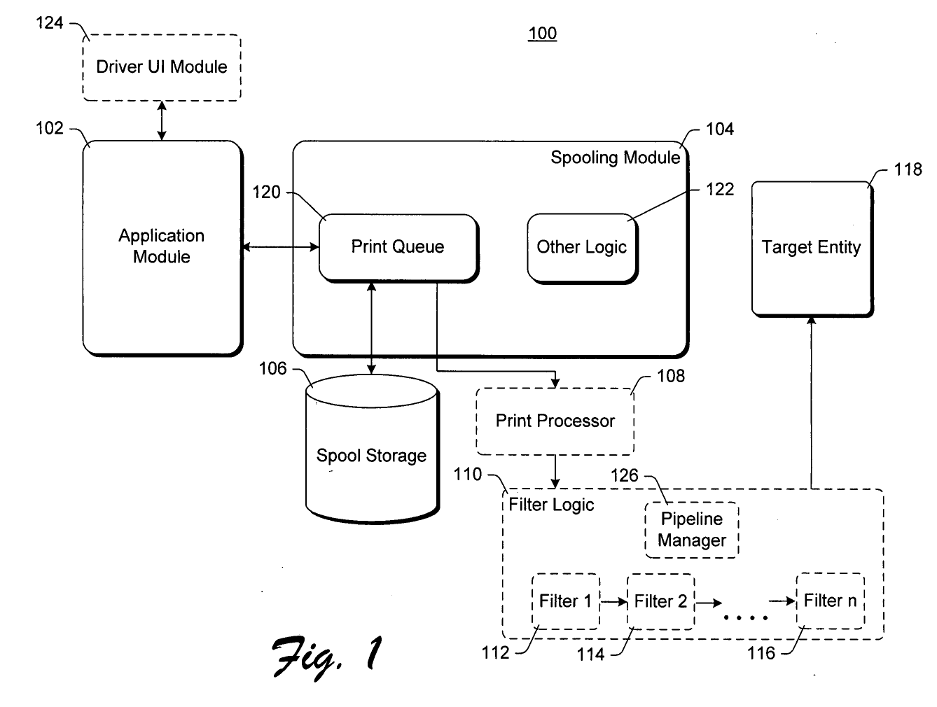

FIG. 1 shows an example system 100 for spooling print jobs. By way of overview, system 100 includes an application module 102 coupled to a spooling module 104. Spooling module 104 receives print job information from application module 102 and stores the print job information in spool storage 106. The print job information includes the data to be printed (e.g., text and/or images), and can have associated with it attribute information regarding how to print the data (e.g., how many copies, additional processing that is to be performed on the data to be printed such as adding of a watermarking or reducing the size of the data to fit on a smaller sheet of paper, and so forth). The print job information typically includes the data to be printed for one print job. A print job is typically a single document, which can include one or more pages. These pages typically correspond to the data that is printed on a single sheet of paper, although various processing functions may be performed to alter the page to paper sheet ratio.

When ready to process the print job, spooling module 104 loads print processor 108, which in turn loads filter logic 110. Filter logic 110 includes multiple (n) filters 112, 114, . . . 116, each to perform different processing functions on the print job information. After processing, the print job information is output by filter logic 110 to a target entity 118. The target entity is typically a printing device that generates a hard copy of the data of the print job, but alternatively could be any of a variety of devices. For example, the target entity could be a device displaying the print job, a device routing the print job elsewhere, a device archiving or otherwise storing the print job, and so on.

The modules, logic and storage units shown in system 100 can be implemented by any of a variety and grouping of physical mechanisms and devices. In certain embodiments, a computing device (not shown) implements application module 102, spooling module 104, spool storage 106, print processor 108, and filter logic 110. More specifically, the various logic and modules (102, 104, 106, 108, and 110) can be implemented by machine readable code stored in the memory of the computing device and executed by the processing unit(s) of the computing device. Spool storage 106 can be implemented by a storage medium (e.g., a hard disk) provided by the computing device. The computing device can operate using any kind of platform (e.g., as defined by the operating system and/or other software configuration of the computing device).

In certain implementations, target entity 118 is a device that is separate from the computing device which implements the other components (102, 104, 106, 108, and 110) of system 100. The computing device can be communicatively coupled to target entity 118 via any kind of communication channel, such as Universal Serial Bus (USB) coupling, parallel coupling, network coupling of any kind, manual transport of removable media, and so forth. In a common case, for instance, target entity 118 comprises a printer for printing documents fed to it by filter logic 110. The computing device can be communicatively coupled to the printer(s) via any kind of hardwired and/or wireless links using any kind of communication protocol. Alternatively, spool storage 106 can be implemented as a removable media and transported to the printer. The target entity 118 can alternatively represent a display device, storage device, other computing device, and so on.

The above allocation of system 100 functions to devices is only an example. In other implementations, different aspects of system 100 can be implemented by separate computing devices. For instance, a first computing device can implement application module 102 and a separate computing device can implement spooling module 104. In other implementations, spool storage 106 can also be implemented as a separate unit which couples to the computing device which implements application module 102 and/or spooling module 104. In other implementations, target entity 118 can be integrated into the same computing device which implements application module 102 and/or spooling module 104. Still other configurations are possible.

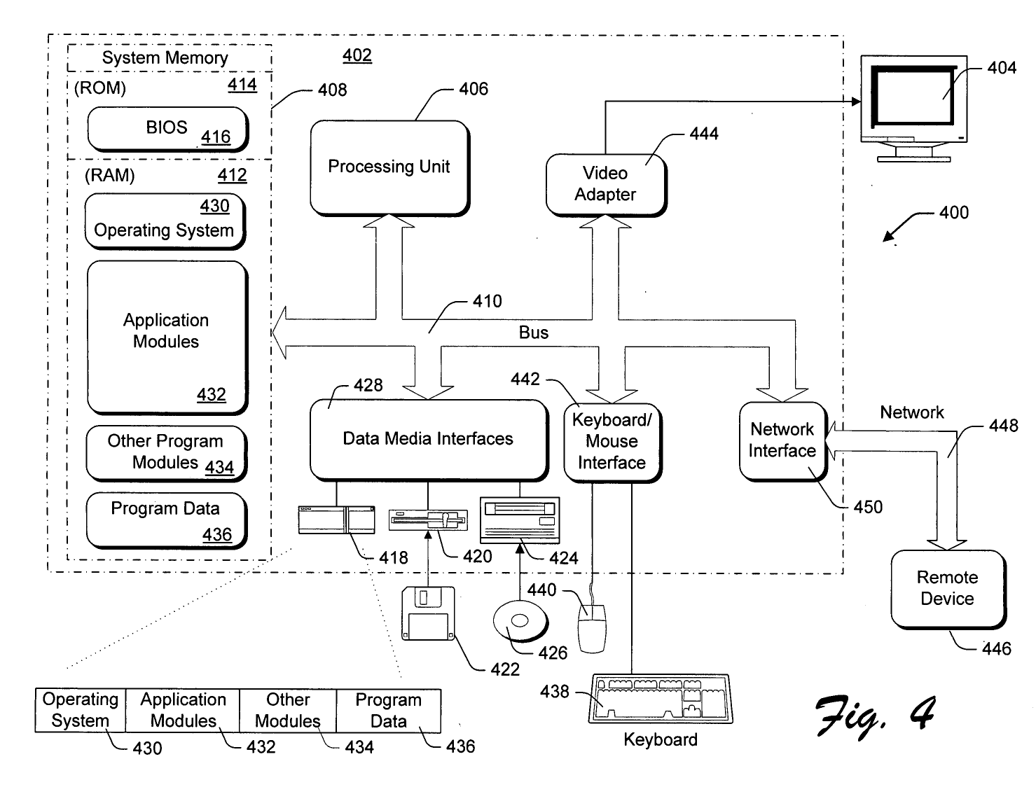

In any event, where one or more computing devices are used to perform aspects of system 100, those computing devices can correspond to any type of computing devices, such as general purpose computing devices, application-specific computing devices (e.g., game consoles such as Xbox® video game system consoles produced by Microsoft Corporation of Redmond, Wash.), portable computing devices (such as a personal digital assistants, mobile phones, etc.), and so on. FIG. 4, discussed below, shows an example computer environment for implementing aspects of system 100.

Application module 102 can be any kind of application module that generates any kind of document. Common types of application modules 102 include text processing programs, spreadsheet processing programs, graphics processing programs, markup language processing programs, database search and retrieval programs, operating system programs, and so on. There is no constraint on the type of application program that can be used to supply print job information to be processed using the system 100. The application module 110 can represent a program implemented in any programming environment; for example, the application module 110 can be implemented as a managed program within the Microsoft Corporation's .NET programming environment.

Although not shown in FIG. 1, one or more intermediary programs or application modules may be situated between application module 102 and spooling module 104, receiving print job information from application module 102 and forwarding it to spooling module 104. Such intermediary programs or applications may make changes to the print job information before communicating it to spooling module 104, or may interact with an interface presented by spooling module 104 that is unknown to or not understood by application module 102.

Spooling module 104 includes a print queue 120. Spooling module 104 can also include generically-labeled other logic 122 for performing other functions that are not pertinent to the focus of this disclosure and therefore will not be described further herein.

Application module 102 communicates with print queue 120 to transmit print job information to spooling module 104. Print queue 120 notifies application module 102 of the data format(s) for print job information that print processor 108 supports, allowing application module 102 to send print jobs to print queue 120 in a format that will be understood by print processor 108. This format can be a format that is also understood by target entity 118, or alternatively may be converted by a filter(s) of filter logic 110 or driver 124 into a format that is understood by target entity 118. Examples of such data formats in which the print job information may be received include raw (e.g., PostScript), Enhanced MetaFile (EMF), XGL, and so forth.

Print queue 120 receives the print job information and stores it in spool storage 106 until target entity 118 is ready to receive the print job information (via print processor 108 and filter logic 110). Print queue 120 may wait, for example, until target entity 118 is finished processing one or more other print jobs, until target entity 118 is otherwise ready to receive an additional print job (e.g., after a paper tray has been refilled or a toner cartridge replaced), until target entity 118 is turned on or coupled to the computing device that includes spooling module 104, and so forth.

Spool storage 106 can be any storage medium, such as RAM memory, magnetic disk, optical disk, solid state memory, and so forth. The storage medium can be fixed or removable. Spool storage may store print job information in a single file, a collection of associated files, or some other storage strategy. Alternatively, spool storage 106 can be transitory information transmitted via a communication channel and inherently retained by that channel during transport.

Spooling module 104 loads print processor 108. Print jobs queued in print queue 120 will be routed for execution in the print processor 108 associated with print queue 120. As used herein, loading of a component (such as print processor 108) refers to making the component available for execution. The loading of a component can include, for example, copying instructions from a nonvolatile storage device to a volatile memory for execution (e.g., from a disk to RAM), allowing the instructions to be executed from the device where they are stored (e.g., from flash memory or other nonvolatile solid state memory), and so forth. Typically, a component is loaded by another component, referred to as the hosting component, and the loading is performed when the hosting component itself is being executed (or being loaded). Alternatively, the loading can be performed at other times, such as when the hosting component is installed on a computing device.

Typically, a print queue 120 is associated with only one print processor 108. In order to support different target entities or different filter logic, different print processors 108 can be loaded by print queue 120. Alternatively, different spooling modules 104 may be executed to support different target entities or different filter logic.

Print processor 108 is illustrated with dashed lines and separately from spooling module 104 to show that print processor 108 is a separate component, but can be loaded by and essentially become part of spooling module 104 during execution. In certain embodiments, print processor 108 is a dynamic link library (DLL) that is loaded or invoked by print queue 120. As part of this loading process, print processor 108 becomes part of spooling module 104 when executing in system 100.

Alternatively, rather than loading print processor 108 such that print processor 108 becomes part of spooling module 104, print processor 108 may be loaded and executed separately from spooling module 104, such as a separate module from spooling module 104. Even though a separate module, print processor 108 maintains an interface allowing print queue 120 to communicate with print processor 108 as discussed herein. However, by maintaining such separation, a fault isolation boundary is created that separates print processor 108 (and filter logic 110 as discussed below) from spooling module 104. Thus, any errors or problems in filter logic 110 or print processor 108 that cause filter logic 110 or print processor 108 to operate incorrectly (e.g., causes filter logic 110 or print processor 108 to crash) does not result in spooling module 104 also operating incorrectly (although it would not be able to employ print processor 108 or filter logic 110 until the problem is resolved, such as by terminating execution of and re-executing print processor 108).

In another alternative embodiment, print processor 108 may be loaded and become part of spooling module 104, but filter logic 110 may be loaded and executed separately from spooling module 104, such as a separate module from spooling module 104. Even though a separate module, filter logic 110 maintains an interface allowing print processor 108 to communicate with filter logic 110 as discussed herein. Analogous to the discussion above, by maintaining such separation between spooling module 104 and filter logic 110, a fault isolation boundary is created that separates filter logic 110 from spooling module 104.

After spooling module 104 begins execution, spooling module 104 loads print processor 108 the first time a print job is communicated to spooling module 104. Spooling module 104 need not re-load processor 108 for subsequent print jobs. However, if spooling module 104 ceases execution, then the next time spooling module 104 begins execution print processor 108 is re-loaded. Alternatively, rather than loading print processor 108 in response to a print job being communicated to spooling module 104, print processor 108 may be loaded when spooling module 104 begins execution.

System 100 also includes a driver UI module 124. Driver UI module 124 is illustrated with dashed lines and separately from application module 102 to show that driver UI module 124 is a separate component, but can be loaded by and essentially become part of application module 102 during execution. In certain embodiments, driver UI module 124 is a dynamic link library (DLL) that is loaded or invoked by application module 102. As part of this loading process, driver UI module 124 becomes part of application module 102 when executing in system 100.

Driver 124 UI module presents a user interface that allows the user of system 100 to select printing features, such as selecting a print quality, selecting a watermark to be printed on each output sheet, selecting whether the size of text and/or images to be printed on a sheet should be reduced or expanded, and so forth. The user can select what processing is to be performed on a particular print job by filter logic 110 via the user interface presented by driver UI module 124. Such selections indicating the type of processing that filter logic 110 is to perform are communicated to print queue 120 by application module 102 or driver UI module 124 along with the print job information.

Driver UI module 124 can also give feedback to the user of system 100 regarding the processing of the print job(s) sent to spooling module 104. For example, this feedback can give an indication of how much of the print job has been printed (or has been sent to target entity 118). In the illustrated example of FIG. 1, driver UI module 124 need not convert the print job to a language that is understood by target entity 118 because that conversion would be performed by a filter(s) of filter logic 110.

It should also be noted that, although filter logic 110 and driver UI module 124 are illustrated as two separate components in FIG. 1, filter logic 110 and driver UI module 124 may be bundled together and distributed as a single component or file. For example, a driver file may be distributed that includes both filter logic 110 and driver UI module 124.

Filter logic 110 includes filters 112, 114, . . . 116 (also referred to as filter modules 112, 114, . . . 116), and pipeline manager 126 (also referred to as pipeline manager module 126). Print processor 108 loads filter logic 110, including pipeline manager 126 and filters 112, 114, . . . 116. Filter logic 110, as well as pipeline manager 126 and filters 112, 114, . . . 116, is illustrated with dashed lines and separately from print processor 108 to show that filter logic 110, including pipeline manager 126 and filters 112, 114, . . . 116, is a separate component from print processor 108 but can be loaded by and essentially become part of print processor 108 during execution. This loading of filter logic 110 can be performed when print processor 108 is loaded by print queue 120, or alternatively at a later time (e.g., the first time a print job is communicated to print processor 108 by print queue 120). As print queue 120 typically loads only one print processor, print processor 108 is responsible for ensuring that the desired processing on the print job information is performed.

It should be noted that, by having print processor 108 load filter logic 110, changes to support the use of filter logic 110 and the filters therein are made to the print processor rather than to the spooling module. No changes need to be made to print queue 120 or other parts of spooling module 104 in order to support the filter logic or the various filters in the pipeline. Print queue 120 and other logic 122 of spooling module 104 need not be aware of, and typically are not aware of, filter logic 110 and the filter pipeline. Any existing spooling module 104 that loads a print processor, whether as a DLL or some other component, can simply load a print processor 108 that invokes filter logic 110 in place of a more traditional print processor.

In alternate embodiments, changes may be made to spooling module 104 to load filter logic 110 directly without requiring loading of a print processor (such as print processor 108). In such embodiments, although no print processor is used, changes to spooling module 104 are made in order to allow spooling module 104 to load filter logic 110 rather than loading a print processor, and to allow print queue 120 to communicate directly with filter logic 110 rather than with a print processor.

Furthermore, it should be noted that print processor 108 is not designed to itself perform the required processing on the print job information. Rather, print processor 108 is designed to know how to load filter logic 110, which in turn performs the required processing on the print job information.

Filters of filter logic 110 perform the required processing on the print job. Filter logic 110 can include one or more filters 112, 114, . . . 116 for performing different processing functions on the print job information to generate an output result. Filters 112, 114, . . . 116 can modify the print job information in various ways, such as by adding a watermark, reducing or expanding the size of text and/or images to be printed on a sheet, causing the text and/or images to be printed double-sided, performing N-up page consolidation (n pages per printed sheet), changing the paper size, changing the page orientation, altering the input bin, changing the color (e.g., monochrome, gray scale, color), changing the print quality, performing font substitution (device font/system font), indicating the output sheets should be stapled, changing the output bin, collating the output sheets, altering the page order (forward/reverse), and so forth. Print job information is passed through one or more of filters 112, 114, . . . 116, each of which can perform different processing on the print job information. The filters can thus be viewed as a filter pipeline, with each filter performing certain processing on the print job information and then allowing the next filter in the pipeline to do so.

In certain embodiments, a filter (or multiple filters) can be set up to modify the print job information by changing its format. For instance, the filter n (e.g., filter 116) (or plural filters) can be used to convert print job information into a form that can be interpreted by target entity 118. In effect, such a filter (or filters) thus serves the rendering or conversion (non-UI) role of a traditional printer driver. For example, filter n 116 may convert the print job information into a page description language (PDL) format that can be fed to a printer which accepts such format. By way of another example, a filter n−1 can convert the print job information into a printer-interpretable format, and filter n 116 can perform post-processing on this format, such that the combination of filter n−1 and filter n can be considered as the printer driver.

Different print jobs may require that different filtering operations be performed on the associated print job information. A pipeline manager 126 can be used to manage the filters in the pipeline, including defining what filters 112, 114, 116 are to be invoked in processing a particular print job, defining how the individual filters 112, 114, . . . . 116 are to be configured, and defining how the filters 112, 114, . . . . 116 are to be chained together. In other words, print processor 108 can create different filter pipelines by chaining the filters 112, 114, . . . . 116 together in different ways. As the filter pipelines can vary, different net effects can be produced for different print jobs. In a series or sequential configuration shown in FIG. 1, for example, filter 112 feeds its output result after completing (or as it completes) its operating on the print job into the input of filter 114, and filter 114 feeds its output result after completing (or as it completes is operating on the print job into to the input of a third filter (not shown), and so on.

More specifically, the type of processing that filter logic 110 performs on the print job information can be controlled by one or more “print tickets” associated with the print job information. The print tickets include attribute information that defines the operations that should be performed on the print job information as it passes through filter logic 110. The attribute information in a print ticket can be generated, for example, based on attribute information provided to print queue 120 by application module 102 along with the print job information. Alternatively, driver 124 may provide a user interface that allows the user to select various attributes for the print job (e.g., attributes for any processing functions supported by filter logic 110, such as watermarking, N-up printing, and so forth). Additionally, filter logic 110 (e.g., pipeline manager 126) may be configured with default values for particular attribute information and includes those default values in the print ticket unless overridden by a user or application module 102. Further details regarding an example of processing using chained filters and print tickets are provided in co-pending and commonly assigned U.S. patent application Ser. No. 10/794,669, entitled “Multilevel Ticket-Based Job Management Architecture for Computing Devices,” filed on Mar. 5, 2004, which is incorporated herein by reference in its entirety.

When target entity 118 is ready to accept a print job, print processor 108 reads the stored print job information from spool storage 106 and forwards the print job information to filter logic 110. The print job information may be passed to pipeline manager 126, or alternatively to a first filter in a chain of filters (e.g., filter 112). The filters 112, 114, . . . 116 perform the appropriate processing functions on the print job information, as identified in the one or more print tickets associated with the print job information. As discussed above, this processing can include converting the print job information to a format that is understood by target entity 118.

In certain embodiments, application module 102 may not be certain of the functionality provided by spooling module 104. Different spooling modules 104 for different operating systems may have different functionality. This functionality can be, for example, different processing functionality that is supported by the spooling module, different notification mechanisms regarding the status of jobs being printed that are supported by the spooling module, and so forth. In such situations, application module 102 determines the operating system of the computing device on which spooling module 104 is running. The operating system determination can be made in different manners. In certain implementations, such as for Microsoft® Windows® operating systems, the determination can be made using the a GetOSVersion API or similar mechanism.

In certain embodiments, application module 102 can determine the functionality provided by spooling modules 104 based on the operating system of the computing device on which spooling module 104 is running. For example, application module 102 can be programmed with an indication of what functionality is provided by spooling modules of different operating systems. Thus, by knowing what operating system is running on the computing device, application module 102 can know what functionality is provided by spooling module 104.

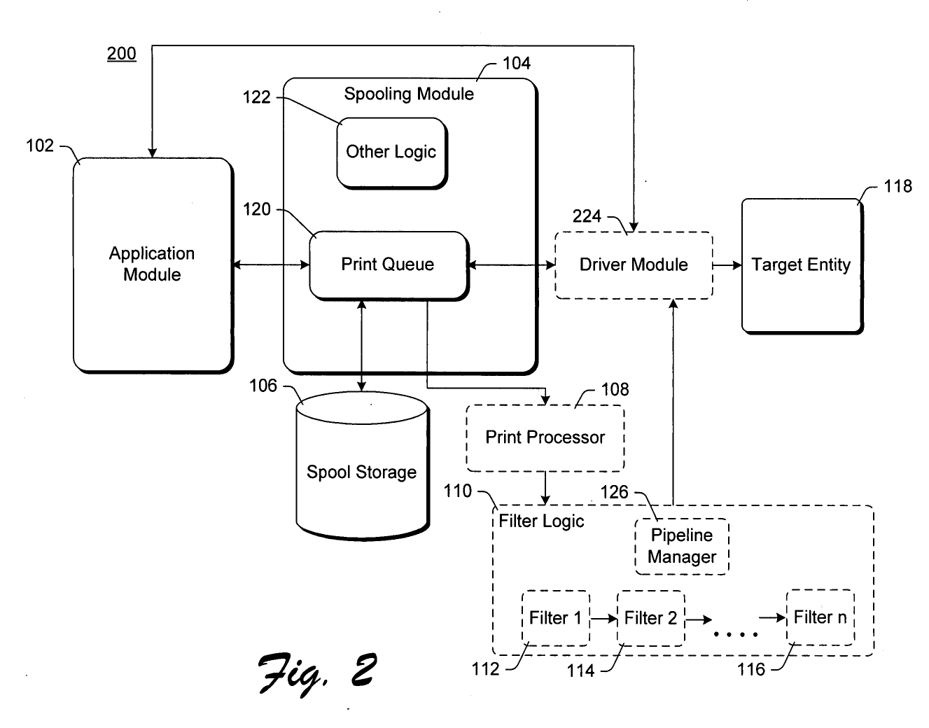

The discussions of FIGS. 1 and 2 above discuss primarily the situation where print queue 120 receives the print job information and stores it in spool storage 106 until target entity 118 is ready to receive the print job information. In alternate embodiments, print processor 108 may forward the print job information to filter logic 110 (optionally after being stored in spool storage 106 for a period of time) for processing of the print job information, and then store the processed print job information in spool storage 106. The processed print job information is typically in a format that is understood by target entity 118 (e.g., a raw format), although could alternatively be in a different format. In this situation, spool storage 106 or spooling module 104 can be viewed as a target entity—thus, the print job information can be viewed as having two target entities: (1) spool storage 106 or spooling module 104; and (2) target entity 118.

This alternative embodiment is particularly useful in situations where target entity 118 is busy, but spooling module 104 has the bandwidth to run filter logic 110. The print job information can be processed and stored in spool storage 106 and then sent to target entity 118 as soon as target entity 118 is ready to receive the information with little or no additional processing of the print job information being needed.

FIG. 2 illustrates another example system 200 for spooling print jobs. In the example system 200 illustrated in FIG. 2, the conversion of the print job to a 19 language that is understood by target entity 118 is performed by driver module 224. The components of system 200 of FIG. 2 operate analogously to the components of system 100 of FIG. 1, except that the conversion of the print job to a language that is understood by target entity 118 is performed by driver module 224 rather than a filter(s) of filter logic 110. The print job information, after being processed by filter logic 110, is forwarded to driver module 224 where it is converted to a language that is understood by entity 118. Driver module 224 provides the same user interface functionality as discussed above with respect to driver UI module 124, and in addition converts the print job information to a language that is understood by entity 118.

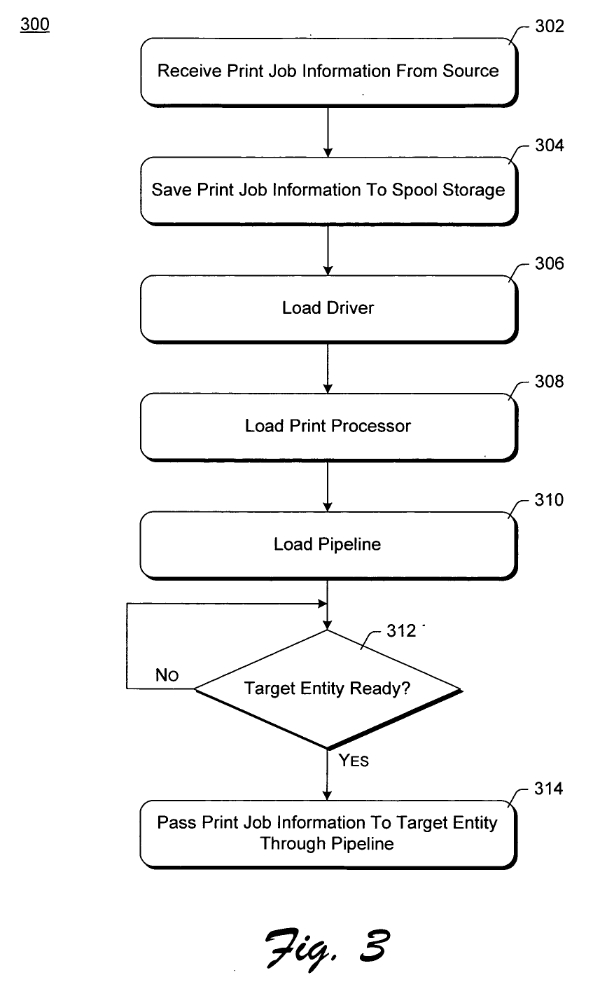

FIG. 3 is a flowchart illustrating an example process 300 for supporting a filter pipeline. Process 300 is an example of the operation of system 100 of FIG. 1 or system 200 of FIG. 2, and is performed by spooling module 104 and print processor 106. Process 300 may be implemented in software, firmware, hardware, or combinations thereof.

Initially, a print queue of the spooling module receives print job information from a source (act 302). This source can be, for example, application module 102 of FIG. 1. Upon receiving the print job information, the print job information is saved to spool storage (act 304). Also upon receiving the print job information, the spooling module loads a driver (act 306) and a print processor (act 308). The print processor also loads a pipeline (act 310) having one or more filters. As discussed above, the driver, print processor, and/or pipeline may have already been loaded. If the driver is already loaded, then act 306 need not be performed. If the print processor is already loaded, then act 308 need not be performed. And if the pipeline is already loaded, then act 310 need not be performed.

The print processor then waits until the target entity is ready to receive the print job information (act 312). The spooling module (e.g., a scheduler (not shown) within the spooling module) can determine when the target entity is ready to receive the print job information in any of a variety of different manners. For example, the target entity may notify the print processor when it is ready. By way of another example, the print processor may repeatedly query the target entity to determine if it is ready. By way of yet another example, another component may monitor the target entity and notify the print processor when the target entity is ready.

When the target entity is ready, the print processor retrieves the print job information from the spool storage and passes the retrieved print job information to the target entity via the pipeline loaded in act 310 (act 314). As discussed above, the processed print job may be passed to the target entity from one of the filters of the pipeline (e.g., as illustrated in FIG. 1), or through a separate driver (e.g., as illustrated in FIG. 2).

Alternatively, rather than passing the print job information through the 11 pipeline after saving it to spool storage, the print job information can be passed through the pipeline as it is being saved to spool storage. For example, as the print job information is still being saved to spool storage, portions of the print job information can be retrieved from the spool storage and passed through the pipeline. By way of another example, the print job information may be passed through the pipeline before it is saved to spool storage.

In another alternate embodiment, the print job information is saved to spool storage and then passed through the pipeline when the spooling module and the pipeline have sufficient bandwidth to process the print job information. The processed print job information is then saved back to spool storage. The processing of the print job information by the pipeline in this alternate embodiment can be performed even though the target entity is not ready.

FIG. 4 illustrates an example computer environment 400 that can be used to implement the functionality described herein. Insofar as a target entity is implemented by a computing mechanism as well, such a computing mechanism can also be implemented using the type of computing environment 400 shown in FIG. 4, or using a related environment.

Computing environment 400 includes a general purpose type computer 402 and a display device 404. Computer 402 represents any of a variety of types of computing devices, such as desktop computers, server computers, mainframe computers, laptop computers, handheld computers, set top boxes, game consoles or gaming systems, and so forth. Further, FIG. 4 shows elements of computer environment 400 grouped together to facilitate discussion. However, computing environment 400 can employ a distributed processing configuration. In a distributed computing environment, computing resources can be physically dispersed throughout the environment.

Computer 402 includes one or more processors or processing units 406, a system memory 408, and a bus 410. Bus 410 connects various system components together. For instance, bus 410 connects processor 406 to system is memory 408. Bus 410 can be implemented using any kind of bus structure or combination of bus structures, including a memory bus or memory controller, a peripheral bus, an accelerated graphics port, and a processor or local bus using any of a variety of bus architectures.

Computer 402 can also include a variety of computer readable media, including a variety of types of volatile and non-volatile media, each of which can be removable or non-removable. For example, system memory 408 includes computer readable media in the form of volatile memory, such as random access memory (RAM) 412, and non-volatile memory, such as read only memory (ROM) 414. ROM 414 includes an input/output system (BIOS) 416 that contains the basic routines that help to transfer information between elements within computer 402, such as during start-up. RAM 412 typically contains data and/or program modules in a form that can be quickly accessed by processing unit 406. Other kinds of computer storage media include a hard disk drive 418 for reading from and writing to a non-removable, non-volatile magnetic media, a magnetic disk drive 420 for reading from and writing to a removable, non-volatile magnetic disk 422 (e.g., a “floppy disk”), and an optical disk drive 424 for reading from and/or writing to a removable, non-volatile optical disk 426 such as a CD-ROM, DVD-ROM, or other optical media. Hard disk drive 418, magnetic disk drive 420, and optical disk drive 424 are each connected to system bus 410 by one or more data media interfaces 428. Alternatively, hard disk drive 418, magnetic 11 disk drive 420, and optical disk drive 424 can be connected to system bus 410 by a SCSI interface (not shown), or other coupling mechanism. Although not shown, computer 402 can include other types of computer readable media, such as magnetic cassettes or other magnetic storage devices, flash memory cards, CD-ROM, digital versatile disks (DVD) or other optical storage, electrically erasable programmable read-only memory (EEPROM), etc.

Generally, the above-identified computer readable media provide non-volatile storage of computer readable instructions, data structures, program modules, and other data for use by computer 402. For instance, the readable media can store operating system 430, application modules 432 (e.g., for implementing application module 102), other program modules 434, and program data 436. The computer readable media can also store, although not shown, logic for implementing spooling module 104, driver 124, print processor 108, and filter logic 110. Any of the above-described storage media can be used to implement spool storage 106, such as hard disk 418.

Computer environment 400 can include a variety of input devices. For instance, computer environment 400 includes keyboard 438 and a pointing device 440 (e.g., a “mouse”) for entering commands and information into computer 402. Computer environment 400 can include other input devices (not illustrated), such as a microphone, joystick, game pad, satellite dish, serial port, scanner, card reading devices, digital or video camera, etc. Input/output interfaces 442 couple the input devices to processing unit 406. More generally, input devices can be coupled to computer 402 through any kind of interface and bus structures, such as a parallel port, serial port, game port, universal serial bus (USB) port, etc.

Computer environment 400 also includes display device 404. A video adapter 444 couples display device 404 to bus 410. In addition to display device 404, computer environment 400 can include other output peripheral devices, such as speakers (not shown), a printer (not shown), etc. Any of these units can constitute target entity 118 of FIG. 1 or FIG. 2.

Computer 402 operates in a networked environment using logical connections to one or more remote computers, such as a remote computing device 446. Remote computing device 446 can comprise any kind of computer equipment, including a general purpose personal computer, portable computer, a server, remote printer or archival device, etc. Any of these units can also constitute target entity 118 of FIG. 1. Remote computing device 446 can include all of the features discussed above with respect to computer 402, or some subset thereof.

Any type of network 448 can be used to couple computer 402 with remote computing device 446, such as a WAN, a LAN, etc. Computer 402 couples to network 448 via network interface 450, which can utilize broadband connectivity, modem connectivity, DSL connectivity, or other connection strategy. Although not illustrated, computing environment 400 can provide wireless communication functionality for connecting computer 402 with remote computing device 446 (e.g., via modulated radio signals, modulated infrared signals, etc.).

Various modules and techniques may be described herein in the general context of computer-executable instructions, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

An implementation of these modules and techniques may be stored on or transmitted across some form of computer readable media. Computer readable media can be any available media that can be accessed by a computer. By way of example, and not limitation, computer readable media may comprise “computer storage media” and “communications media.”

“Computer storage media” includes volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

“Communication media” typically embodies computer readable instructions, data structures, program modules, or other data in a modulated data signal, such as carrier wave or other transport mechanism. Communication media also includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above are also included within the scope of computer readable media.

More generally, any of the functions described herein can be implemented using software, firmware (e.g., fixed logic circuitry), manual processing, or a combination of these implementations. The terms “module,” “functionality,” and “logic” as used herein generally represents software, firmware, or a combination of software and firmware. In the case of a software implementation, the terms “module,” “functionality,” or “logic” represent program code that performs specified tasks when executed on a processing device or devices (e.g., CPU or CPUs). The program code can be stored in one or more fixed and/or removable computer readable memory devices.

The above-mentioned processing device(s) can be implemented in different ways. For example, the processing device(s) can be implemented using semiconductor transistor-based computing mechanisms (e.g., by electronic integrated circuits (ICs) or fixed electronic logic circuitry). Alternatively, the processing device(s) can be implemented, in whole or in part, using quantum computing mechanisms, optical computing mechanisms, mechanical computing mechanisms, biological computing mechanisms, and so forth.

In closing, a number of examples were presented in this disclosure in the alternative (e.g., case A or case B). In addition, this disclosure encompasses those cases which combine alternatives in a single implementation (e.g., case A and case B), even though this disclosure may not have expressly mention these conjunctive cases in every instance.

Although the description above uses language that is specific to structural features and/or methodological acts, it is to be understood that the invention defined in the appended claims is not limited to the specific features or acts described. Rather, the specific features and acts are disclosed as example forms of implementing the invention.

What is claimed is:

1. One or more computer readable media having a plurality of instructions to implement a spooling module, wherein the plurality of instructions, when executed by one or more processors, causes the one or more processors to:
receive a print job from an application module; and
load a print processor, the print processor loading a filter pipeline having a plurality of filters, each of the plurality of filters performing one or more processing functions on the print job prior to the print job being forwarded to a target entity.

2. One or more computer readable media as recited in claim 1, the plurality of filters operating sequentially on the print job, wherein each of one or more of the plurality of filters outputs a result of the filter processing the print job to another of the plurality of filters.

3. One or more computer readable media as recited in claim 1, wherein one of the plurality of filters forwards the print job, after having the one or more processing functions performed thereon, to the target entity.

4. One or more computer readable media as recited in claim 1, wherein one of the plurality of filters forwards the print job, after having the one or more processing functions performed thereon, to a driver for conversion of the print job to a format understood by the target entity.

5. One or more computer readable media as recited in claim 1, wherein the target entity comprises a printing device.

6. One or more computer readable media as recited in claim 1, wherein the target entity comprises a spooling module.

7. One or more computer readable media as recited in claim 1, wherein the print processor loads a filter logic that includes the filter pipeline and a pipeline manager to manage the plurality of filters in the filter pipeline.

8. One or more computer readable media as recited in claim 1, the print queue having no knowledge that the filter pipeline having the plurality of filters exists.

9. One or more computer readable media as recited in claim 1, wherein one or both of the print processor and the filter pipeline are executed as a separate module from the spooling module.

10. A spooling module comprising:
a print queue to receive print job information from a source; and
a print processor associated with the print queue, the print processor being configured to load a filter pipeline and forward the print job information received from the print queue to the filter pipeline.

11. A spooling module as recited in claim 10, the filter pipeline including a plurality of filters chained together in a series configuration in which each of one or more of the plurality of filters generates a result by processing the print job information and outputs the result to another of the plurality of filters.

12. A spooling module as recited in claim 10, wherein the print queue is further to store the print job information in a spool storage and subsequently retrieve the print job information from the spool storage and forward the retrieved print job information to the print processor.

13. A spooling module as recited in claim 10, wherein the print processor comprises a dynamic link library (DLL) loaded by the print queue

14. A spooling module as recited in claim 10, the print processor being configured to load the filter pipeline by loading a filter logic that includes the filter pipeline and a pipeline manager to manage a plurality of filters in the filter pipeline.

15. A spooling module as recited in claim 10, the print queue having no knowledge of the existence of the filter pipeline.

16. A method, implemented in a computing device, the method comprising:
a print queue of a spooling module receiving print job information from a source;
the print queue saving the print job information to a spool storage of the spooling module;
a print processor, loaded by the spooling module, loading a filter logic including a manager module and a plurality of filter modules; and
the print processor retrieving the print job information from the spool storage and passing the print job information through the filter logic for processing of the print job information by the plurality of filter modules.

17. A method as recited in claim 16, each of one or more of the plurality of filter modules generating a result by processing the print job information and outputting the result to another of the plurality of filter modules.

18. A method as recited in claim 16, further comprising:
one of the plurality of print filter modules forwarding the print job information, after being processed by the plurality of filter modules, to a target entity.

19. A method as recited in claim 16, further comprising loading the print processor in response to receipt of the print job information from the source.

20. A method as recited in claim 16, wherein the print processor comprises a dynamic link library (DLL).
